(19) United States
(12) Patent Application Publication
(10) Pub. No.: US 2003/0036997 A1
(43) Pub. Date: Feb. 20, 2003

(54) System and method for fraud prevention in automated electronic payment processing

(75) Inventor: Laurence A. Dunne, Tamarac, FL (US)

Correspondence Address: HOLLAND & KNIGHT, LLP, ONE EAST BROWARD BLVD., SUITE 1300, FT LAUDERDALE, FL, 33301

(73) Assignee: Internet Billing Company, Ltd.

(21) Appl. No.: 09/929,988

(22) Filed: Aug. 14, 2001

(51) Int. Cl. G06F 17/60

(52) U.S. Cl. 705/39; 705/26

(57) ABSTRACT

A method and system for combating fraud in electronic payment transactions over the Internet comprises embedding a globally unique identifier number in each customer data page submitted for credit approval on an Internet web site, and undertaking a fraud analysis to prevent the use of multiple copies of the same customer data page, each containing different sets of stolen or made up customer data, in an effort to determine which sets of customer data are associated with valid credit cards.

### FIELD OF THE INVENTION

This invention relates to automated electronic payment processing of goods or services, and, more particularly, to a system and method for limiting the incidence of fraud in transactions between buyers and sellers over the Internet in which credit is approved on line as payment for goods or services.

### BACKGROUND OF THE INVENTION

The use of the worldwide network of computers or Internet in commercial transactions has undergone explosive growth in the past several years. New companies as well as traditional retailers have developed web sites for the advertisement and sale of their goods and services over the Internet. A typical transaction proceeds as follows. An end user or purchaser logs onto the Internet via an Internet Service Provider and visits the web site of a seller offering a particular product or service of interest. Depending on the configuration of the web site, an order can be placed for a single item, or a number of items can be selected and placed in a “shopping basket” for purchase. Alternatively, in the case of services, the end user indicates his or her choice of a particular service offered by the seller, such as access to a given web site.

Once a selection of a product or service has been made, an “order” or “join” button is activated by the buyer on the seller's web site which initiates a chain of events relating to credit approval of the buyer, and then shipment of a product or initiation of the service selected by the buyer. Focusing on the credit approval aspect of the transaction, the activation of an order or join button by the buyer transmits a signal to a server operated by the seller, or by a third party payment processing service acting on behalf of the seller, to provide notice of the request. The server queries the buyer as to the mode of payment to be employed, and, for purposes of the present discussion, the assumption is that the buyer wishes to pay with a credit card.

Unlike transactions in the physical world where sales persons accepting a credit card for payment can observe the buyer, request photo identification and compare the signature of the buyer with the one appearing on the credit card being used, transactions over the Internet are essentially anonymous. Theft of credit cards is commonplace, and efforts have been made to provide at least some protection to sellers in Internet transactions against the unauthorized use of credit cards. Typically, the server of the seller or its payment processing service displays a join page or data page to begin the credit approval process. The data page requires the buyer to list a number of items of information such as the credit card number, its expiration date, the name of the account holder, his or her address and other information. In some instances, particularly among third party payment processing services engaged by the seller, the information collected from the data page is subjected to an initial analysis in the data bases of such third party, e.g., comparisons are conducted of the data submitted with known stolen credit cards, unauthorized users, etc. The data is also transmitted to the server of the issuer of the credit card which performs its own analysis and confirms the credit available on a particular card. After these analyses are completed, the buyer receives an indication of approval or rejection of the request for credit, and the transaction is either rejected or proceeds with a confirmation of shipment of the product or initiation of the service being purchased.

There have been many attempts to defeat or circumvent the process of credit approval noted above. One technique involves the use of copies of the join page or data page to check on whether a particular combination of customer data is associated with a valid credit card or not. In this particular type of fraud, the perpetrator typically creates a program containing a large number of combinations of customer data, e.g., credit card numbers, expiration dates, account holder names and addresses, which may have been obtained from lost or stolen cards, or simply made up. The perpetrator logs on to a web site, brings up the join or data page, and, using a programming technique, combines individual sets of the stolen or made up customer data with a separate copy of the same join or data page. Each copy of the bogus join or data page created by the perpetrator is processed for credit approval in the manner described above, thus providing an indication of which sets of customer data are “good” or approved for the transaction, and which are not. The perpetrator notes each data set associated with an active credit card, and is then free to use such information in subsequent transactions of his or her choice over the Internet, via mail order or telephonic order and any other credit card transaction where the buyer need not be physically present to use a credit card for the purchase of goods or services.

### SUMMARY OF THE INVENTION

It is therefore among the objectives of this invention to provide a method and system for the reduction of Internet fraud involving the creation of multiple copies of join or data pages completed with stolen or made up credit card data, and the subsequent submission of such data pages for credit approval as part of an Internet transaction.

These objectives are accomplished in a method and system according to this invention in which a technique is employed to uniquely identify each join page or data page completed by a prospective buyer as part of an Internet transaction, and then perform a fraud analysis in the event two or more join pages or data pages are presented for credit approval with the same identifying indicia or with no identifying indicia at all.

This invention is predicated upon the concept of defeating the creation of multiple copies of the same join page or data page generated in the course of an Internet transaction, in which each copy is provided with stolen or made up customer data and then presented for credit approval on the same web site. In the presently preferred embodiment, the ordering process in an Internet transaction proceeds in the manner described above up to the point where the completed join page or data page is submitted for credit approval. Software associated with the server operated by or on behalf of the Internet seller generates a globally unique identifier (“GUID”) number using information immediately available at the time of the transaction, and then embeds the GUID number in the join or web page. The GUID number is generated from such data as the IP address of the buyer, the particular browser used by the buyer, the time the buyer logged on to the web site or made the credit request, and/or other information unique to the buyer. This combination of several pieces of data, and the fact that such data is instantaneously available at the time the transaction is being processed, ensures that a unique and secure GUID number is generated for each join or data page. No two pages have the same GUID number.

The GUID number is hidden from view on the join or data page, and recorded on the server of the seller. When the join or data page is submitted for credit approval, it is initially transmitted to the server of the seller where a comparison is made between the GUID number embedded on the join or data page and the list of GUID numbers stored in memory in the server. If the GUID number on the join or data page is found to match with a GUID number stored in the server, and there have been no previous matches of such GUID number, the request for credit approval is allowed to proceed in essentially the same manner as described above for typical transactions. In the event it is determined that the GUID number on the newly submitted join or data page has been presented to the server more than once, or if such page has no GUID number, a “fraud analysis” is conducted. This fraud analysis involves a consideration of the re-use of the join or data page, and a determination of the type of fraud involved. For example, if a particular data page has just been used in another successful transaction on that same web site, it is unlikely that an end user would be making another attempt to buy the same product over again. In that case, the assumption is made that the end user is testing multiple credit card numbers and the transaction would be blocked. Additionally, the fraud analysis involves a comparison of information contained on newly submitted data pages with existing data pages to ascertain whether or not the information on both pages is significantly different. Minor variations which could be attributed to typographical errors on the part of the buyer would not terminate the credit approval process, but major differences would.

### DESCRIPTION OF THE DRAWINGS

The structure, operation and advantage of the presently preferred embodiment of this invention will become further apparent upon consideration of the following description, taken in conjunction with the accompanying drawings wherein:

FIG. 1 is a schematic flow chart of a method and system according to this invention for the detection of fraud in an Internet transaction involving the approval of credit; and

FIG. 2 is a schematic view of that portion of the flow chart in FIG. 1 labeled the “GUID number comparison” and the “fraud analysis.”

### DETAILED DESCRIPTION OF THE PREFERRED EMBODIMENT

Referring now to the drawings, the fraud prevention method and system of this invention is schematically depicted in block diagram form. For ease of discussion, the invention is described with reference to the sequence of a typical Internet transaction in which an end user or customer visits the web site of a seller, orders a product or service and seeks to pay with a credit card.

Initially, the end user 10 logs on to the Internet, represented by box 12, through any of a number of Internet Service Providers. Once on the Internet, the end user enters the web site 14 of a seller of a product or service, which, for purposes of the method of this invention, is identified as receiving content from the seller 16. Details of the operation of the web site 14 form no part of this invention, and are therefore not discussed herein. It is contemplated that essentially any type of site in which goods or services are offered for sale would benefit from and be capable of use with the method and system of this invention.

Once on the web site 14, the end user 10 selects one or more products or services of interest and decides to make a purchase. Box 18 schematically depicts the interactive steps required by a particular web site 14 to actually select an article or service or interest, and then initiate the purchase sequence. These steps generally include a search of the site for a particular product or service, the identification of one or more products of interest, the selection of a particular mode of payment and then the activation of an order or join button to initiate the credit approval sequence. For purposes of the present discussion, the mode of payment is presumed to be with a credit card, although it is contemplated that the method and system of this invention can be employed with payment options which include personal checks and other methods of payment.

Once the order or join button is activated, the order information from the web site 14 is transmitted to a server 20 which is preferably encrypted and provided with additional security features. The server 20 can be maintained by the seller 16, but in most instances a third party payment processing service would be employed by the seller 16 to assist with the credit approval process and to avoid fraud in the manner described in detail below.

In a typical prior art Internet transaction, upon receipt of the order information from the web site 14, the server 20 displays a customer data page as depicted in box 22. Customer data pages 22 require the end user 10 to respond to a series of requests for information such as the credit card number, its date of expiration, the name of the end user, his or her home address and other information. Once this information is provided by the buyer, the data collected is transferred to the issuer of the credit card which executes a credit approval routine including a comparison of the data with its own records, a check of the credit limit on the credit card presented by the end user and the like. The payment collection service employed by the seller may also perform a credit check of its own on the server 20, comparing the information entered by the prospective buyer on the data page with its internal records of invalid credit cards, buyers with bad credit, bogus home addresses and other records. If the request for credit is approved at the server 20 and remotely by the credit card issuer, the transaction is allowed to proceed and the product(s) will be shipped to the end user or the service being sought will begin.

This invention is directed to a specific type of fraudulent activity which occurs in the sequence of credit approval described above. It has been discovered that the credit approval process can be used to screen credit card information in order to determine which combinations of customer data are associated with active cards. The fraud is accomplished by devising a computer program containing a large number of “data sets” each including a particular combination of end user information of the type which must be entered on the customer data page 22 noted above, e.g. credit card number, expiration date, customer name and address etc. This data may have been stolen by the end user, or it could simply be made up on a random basis. The computer program also functions to make multiple copies of the customer data page 22 displayed by the server 20, and enter one set of customer data on each copy of the data page 22. The individual pages 22, in turn, are sequentially processed for credit approval in the manner described above. If any of the data sets of customer information are approved for credit, the end user has successfully identified a valid credit card which in fact belongs to another individual or entity. This customer information can be used to illegally purchase goods or services up to the credit limit of the credit card in virtually any type of transaction where the buyer need not be physically present.

In order to combat fraudulent activities of this type, the method and system of the present invention operates to prevent the processing of multiple copies of the same customer data page 22 at a given web site for credit approval. In the presently preferred embodiment, software either associated with or connected to the server 20 creates a globally unique identifier or GUID number from data available instantaneously at the time the request to purchase is initiate. This data may include the IP address, the time of the request to purchase, the identity of the browser employed to reach the web site and various end user specifics. By using multiple data references, the combination of which is unique at the time of the request to purchase, a one-of-a-kind GUID number is generated for each credit approval request. The GUID number derivation, and the generation of the GUID number itself, are schematically depicted in boxes 24 and 26, respectively. Although represented as discrete functions for ease of illustration, the GUID number derivation functions shown as boxes 24 and 26 are preferably executed by software in the server 20. Each GUID number is stored in the server 20 for later comparison purposes, as described below.

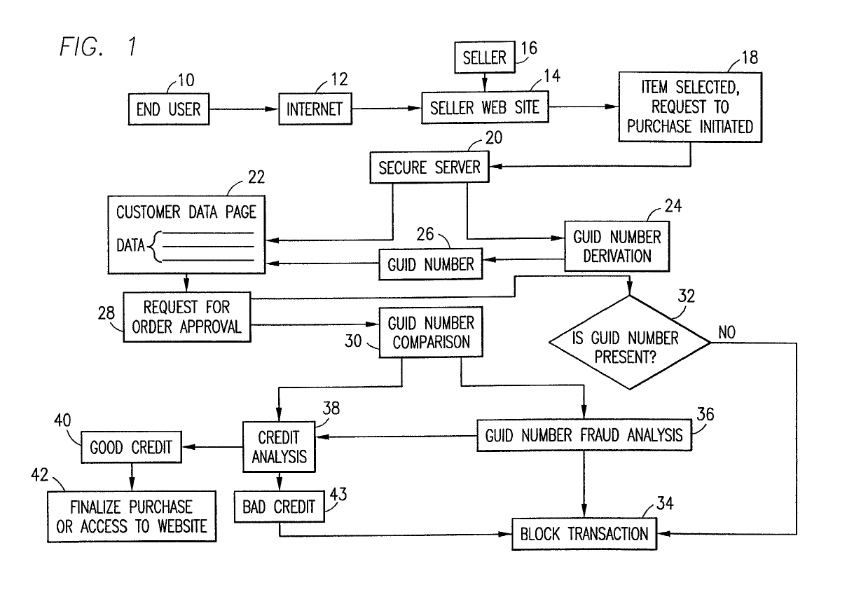

Once a GUID number is generated for a particular credit approval request, it is embedded in a customer data page represented by box 22. Each data page 22 is provided with a unique GUID number, which is hidden from the view of the end user. After completion of the data page 22 by the end user, and the assigned GUID number is embedded in the data page 22, the information entered by the end user on the data page 22 proceeds to the credit approval process which begins with the credit request depicted at box 28 in FIG. 1. Initially, the data page is electronically transmitted to software represented by boxes 30 and 32. At box 32, the data page is examined for the presence of a GUID number. If none is present, a signal is sent to what is schematically shown as a “block transaction” box 34. The block transaction 34 function is representative of software associated with or connected to the server 20 which is effective to deny the request for credit approval and end the transaction.

In parallel with the inquiry conducted at box 32, a GUID number comparison is made at box 30, which either results in the performance of a fraud analysis involving GUID numbers as represented by box 36 in FIG. 1, or a credit analysis shown in FIG. 1 by box 38. The credit analysis represented by box 38 is a conventional risk scoring analysis of a credit card, a check and/or the individual purported to be the owner of the credit card or holder of the checking account. Data bases maintained by the payment processing firm employed by the seller 16, the company which issued the credit card and/or the bank at which the checking account is held are activated to determine whether or not the information from the data page identifies a legitimate end user with sufficient credit worthiness to complete the proposed transaction. As schematically shown in FIG. 1, if it is determined from the credit analysis that the end user has “good credit” as depicted in box 40, the purchase is finalized usually with an indication of shipment of the article purchased or perhaps a link to the site where a service has been purchased. See box 42 in FIG. 1. A credit analysis resulting in an unacceptable or inadequate credit report and/or the presence of other types of consumer fraud, as at box 43 entitled “bad credit,” causes the block transaction 34 function to execute and deny the end user the purchase he or she sought.

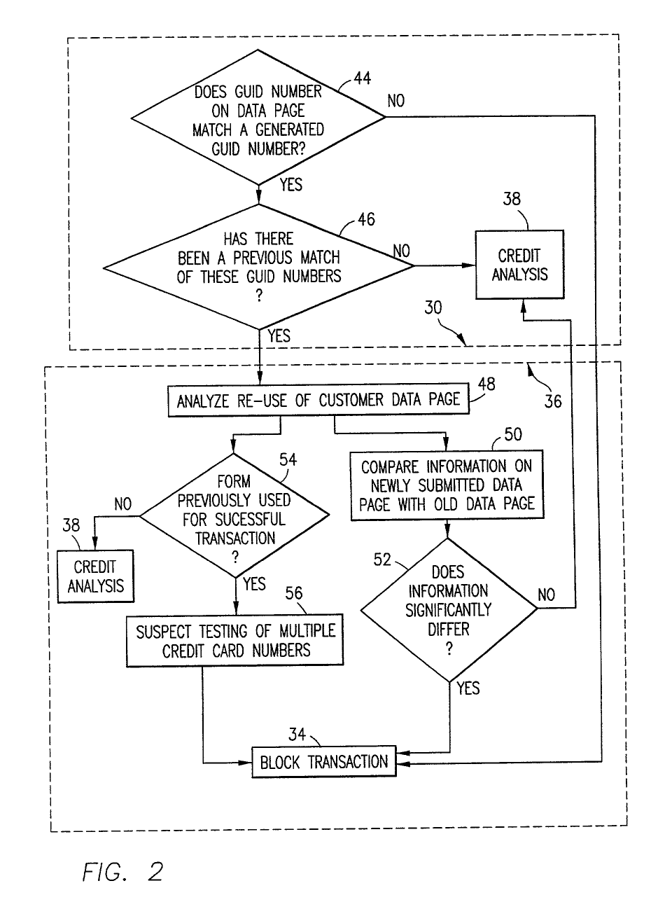

With reference to FIG. 2, details are shown of the GUID number comparison function represented by box 30 in FIG. 1 and the fraud analysis function involving GUID numbers of box 36. As noted above, software associated with the server 20 generates a unique GUID number for each data page 22 which is then embedded in the data page 22 without being visible to the end user. A record of the GUID numbers generated, and the data page 22 with which each GUID number is associated, is maintained in the memory of the server 20. The GUID number comparison function, depicted by box 30 in FIG. 1, actually consists of the two step process shown in FIG. 2. Initially, a comparison is made of the GUID number embedded on a given data page with the list of GUID numbers stored in the server 20. This comparison is represented by the box 44 in FIG. 2. If no match is found, the block transaction function represented by box 34 is activated and the request for order approval is terminated at that time. Because each legitimate GUID number generated is immediately associated with a discrete data page 22, there must be a match between the GUID number on the data page 22 presented for credit approval and one of the GUID numbers stored in memory at the server 20. Moreover, since each GUID number is unique and associated with only one data page 22, there must be only one match. Consequently, the match sequence proceeds from box 44 with the indication “yes” there has been a match of the GUID numbers, to a box 46 which is representative of an inquiry made as to whether or not there has been a previous match of the GUID number on the data page 22 presented for credit analysis and a GUID number stored in the server 20. If an end user has attempted to copy the same data page 22 a number of times and incorporate different data sets on each copy as part of the fraud scheme described above, the inquiry represented by box 46 will identify that attempt by noting the use of the same GUID number more than once. If there has not been a previous match of the GUID number embedded in the data page with a discrete GUID number stored in the server 20, depicted by the “no” arrow in FIG. 2, the credit analysis can proceed as described above in connection with a discussion of boxes 38, 40, 42 and 44.

The “yes” designation extending from box 46 represents a signal transmitted to the fraud analysis sequence identified by box 36 in FIG. 1, but depicted in more detail in FIG. 2. In the event of a previous match between a GUID number on a data page presented for credit analysis and a GUID number stored on the server 20, a fraud analysis is executed which involves an inquiry regarding re-use of a customer data page. See box 48. One path of inquiry, illustrated on the right hand portion of FIG. 2, begins with a comparison of the end user information or data set incorporated in the newly submitted data page 22 and an “old” or existing data page associated with a particular GUID number. See box 50. In addition to storing each GUID number generated, the server 20 records the information contained in the data page associated with the corresponding GUID number. As such, an analysis can be made of the content on a newly submitted data page 22 with the customer information of record on an “old” or original data page associated with a given GUID number. This comparison is identified in box 52 as determining whether the information on the newly submitted data page 22 “significantly differs” from the content on the data page 22 already of record in the server 20.

It is contemplated that in conducting the fraudulent credit approval activities noted above, substantial or significant differences will be present in the customer data entered on different copies of the same data page, e.g. end user name, address, credit card number and expiration date etc. Such substantial differences are represented by the “yes” arrow from box 52 which activates the block transaction function of box 34 to terminate the credit approval process. On the other hand, if a legitimate end user submits a completed data page 22 and then realizes he or she made a typographical error, it is possible that the end user would choose to bring up the data page again using the “back” button of the browser so that the error could be corrected. Such a correction would be attempted in lieu of exiting the seller's web site 14 and starting the entire transaction over again. The inquiry represented by box 52 is therefore intended to allow for minor discrepancies in content between newly submitted data pages 22 and those of record on the server 22 to account for such minor errors on the part of the end user. In such cases of typographical errors or the like, the credit analysis is allowed to proceed, as represented by the “no” arrow extending from box 52 to the credit analysis depicted at box 38.

A second path of inquiry or fraud analysis is shown on the left hand side of FIG. 2. Box 54 represents a query in which the newly submitted data page 22 and corresponding GUID number are reviewed to determine whether or not they have been previously used in a successful transaction. It is considered highly unlikely that a legitimate end user would attempt to process account information in order to purchase a particular product or service immediately after having successfully purchased the same item or service. The “yes” arrow extending from box 54, indicating that the same credit information from a successful transaction is being immediately re-used, therefore leads to box 56 which is representative of an instruction sent to the block transaction function 34 based upon the suspected fraudulent testing of multiple data sets or credit information by an end user. If the data page 22 has not been used in a previous successful transaction, identified by the “no” arrow extending from box 54, the credit analysis represented by box 38 is allowed to proceed.

While the invention has been described with referenced to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of combating fraud in electronic payment transactions conducted over the Internet, comprising:
(a) presenting a customer data page from a server to a potential buyer of a product or service displayed on the Internet web site of a seller for completion by the buyer with selected information;
(b) generating a globally unique identifier number which is embedded in the customer data page and stored in the memory of the server;
(c) comparing the globally unique identifier number embedded in the customer data page with the globally unique identified number stored in memory in the server upon submission of the customer data page for credit approval; and
(d) executing a fraud analysis in the event the globally unique identifier number embedded in the customer data page submitted for credit approval is determined to have previously matched a globally unique identified number stored in the memory of the server.

2. The method of claim 1 in which step (a) comprises employing a secure, encrypted server to receive a purchase request from the buyer, and generating the customer data page on the server in response to the purchase request.

3. The method of claim 2 in which step (b) comprises generating the globally unique identifier number from data transmitted to the server upon receipt of the purchase request from the buyer.

4. The method of claim 3 in which the data transmitted to the server for generation of the globally unique identifier is selected from the following:
(i) the time when the purchase request was made;
(ii) the identity of the web browser used by the buyer;
(iii) the IP address of the buyer; and
(iv) the buyer information entered on the customer data page.

5. The method of claim 1 in which step (b) includes embedding the globally unique identifier number in the customer data page so that it is not visible to the buyer.

6. The method of claim 1 in which step (b) includes generating a globally unique identifier number which is unique to each customer data page.

7. The method of claim 1 further including the step of determining whether or not a globally unique identifier number is embedded in the customer data page presented for credit approval, and blocking the transaction in the event no globally unique identifier number is present.

8. The method of claim 1 in which step (d) comprises determining whether the customer data page has been used in a successful transaction on the Internet web site of the seller immediately prior to the submission of the same customer data page for credit approval.

9. The method of claim 8 in which the transaction is blocked in the event the same customer data page used in a successful transaction on the Internet web site of the seller is submitted again for credit approval immediately after the successful transaction is completed.

10. The method of claim 1 further comprising storing in the memory of the server the customer information entered on each customer data page and the globally unique identifier associated with each of said customer data pages.

11. The method of claim 10 in which step (d) comprises comparing the customer information and the globally unique identifier number associated with a customer data page submitted for credit approval with the customer information and globally unique identifier number contained on a customer data page stored in memory in the server.

12. The method of claim 11 in which the transaction is blocked in the event significant differences are detected in comparing the customer information contained on the customer data page submitted for credit approval and the customer information listed on a customer data page stored in the memory of the server.

13. A method of combating fraud in electronic payment transactions conducted over the Internet, comprising:
(a) presenting a customer data page from a server to a potential buyer of a product or service displayed on the Internet web site of a seller for completion by the buyer with selected information;
(b) employing selected information available at the time the customer data page is completed by the buyer to generate a globally unique identifier number;
(c) embedding the globally unique identifier number in the customer data page;
(d) storing the information contained on the customer data page, and the globally unique identifier number associated with said customer data page, in the memory of the server;
(e) comparing the globally unique identifier number embedded in the customer data page with the globally unique identified number stored in memory in the server upon submission of the customer data page for credit approval; and
(f) executing a fraud analysis in the event the globally unique identifier number embedded in the customer data page submitted for credit approval is determined to have previously matched a globally unique identified number stored in the memory of the server.

14. The method of claim 13 in which step (b) comprises employing at least some of the following information to generate the globally unique identifier number:
(i) the time when the purchase request was made;
(ii) the identity of the web browser used by the buyer;
(iii) the IP address of the buyer; and
(iv) the buyer information entered on the customer data page.

15. The method of claim 14 in which step (b) includes embedding the globally unique identifier in the customer data page so that it is not visible to the buyer.

16. The method of claim 13 in which step (b) includes generating a globally unique identifier number which is unique to each customer data page.

17. The method of claim 13 further including the step of determining whether or not a globally unique identifier number is embedded in the customer data page presented for credit approval, and blocking the transaction in the event no globally unique identifier number is present.
